(19) United States
(12) Patent Application Publication
(10) Pub. No.: US 2025/0342546 A1
(43) Pub. Date: Nov. 6, 2025

(54) SYSTEMS AND METHODS FOR PROVIDING A USER WITH AN INTERACTIVE PERSONALIZED GUIDANCE WITH RESPECT TO ACADEMIC PROGRAMS

(71) Applicant: APPLYBOARD INC., Kitchener (CA)

(72) Inventors: Siddhartha SENGUPTA, Toronto (CA); Haitham AMAR, Waterloo (CA)

(21) Appl. No.: 19/197,074

(22) Filed: May 2, 2025

Related U.S. Application Data
(60) Provisional application No. 63/642,418, filed on May 3, 2024.

(51) Int. Cl. G06Q 50/20; G06F 16/2455; G06F 16/2457; H04L 67/306

(52) U.S. Cl. CPC G06Q 50/2053; G06F 16/2455; G06F 16/2457; H04L 67/306

(57) ABSTRACT

Various methods and systems for providing a user with an interactive engagement with respect to academic programs are disclosed herein. The systems and methods disclosed herein involve receiving a user input in a natural language format that includes academic program inquiries, evaluating the user input to determine whether the user input is sufficient for determining an engagement intent of the user with the academic program guidance system and if so, translating the user input into prompt inputs according to a set of academic engagement prompts providing a framework for correlating the user input against databases. The systems and methods disclosed herein further involve generating a set of search queries based on the prompt inputs, executing the set of search queries at the databases and generating a program guidance output in reply to the user input in natural language and addressing the academic program inquiries.

### CROSS-REFERENCE TO RELATED APPLICATION(S)

This application claims the benefit of U.S. Provisional Patent Application No. 63/642,418 filed on May 3, 2024, entitled “Systems and Methods for Providing a User with an Interactive Personalized Guidance with Respect to Academic Programs”. The entirety of U.S. Provisional Patent Application No. 63/642,418 is incorporated herein by reference.

### FIELD

The described embodiments generally relate to intelligent academic program guidance systems for providing a user with an interactive engagement with respect to academic programs and methods of operating thereof.

### BACKGROUND

When applying to academic programs, such as post-secondary academic programs, many applicants do not know what programs to submit applications for, due to lack of knowledge about academic programs that may exist. When researching academic programs, applicants can feel overwhelmed by the number of programs and academic institutions. The application process can be complicated or difficult, even for applicants who know their interests and strengths and weaknesses, since each academic institution can have different admissions criteria, and can be associated with different post-graduation employment outcomes. Obtaining information about these different academic institutions can also be tedious since the information is often spread across multiple webpages.

To assist with the application process, applicants often turn to friends, family, and/or academic advisors, and information available online (e.g., blogs, forums, etc.). However, information from friends and family is often based on personal experience or hearsay, which can be unreliable, while advice from academic advisors can be limited by the academic advisors' geographical location and previous experience (e.g., previous applicants the academic advisors have worked with).

In many cases, it can also be difficult for an academic advisor working with a large number of applicants to ask the correct questions to assess each applicant's interests or intent, particularly if an applicant does not feel at ease sharing information about themselves. Even when an academic advisor is able to assess an applicant's interests and intent, the academic advisor may struggle to use this information in an effective manner to provide the applicant with tailored guidance. In many cases, applicants may also have questions that are specific to their application or profile, which cannot be easily addressed by an academic advisor.

### SUMMARY

The various embodiments described herein generally relate to intelligent academic program guidance systems for providing a user with an interactive engagement with respect to academic programs and methods of operating thereof.

In accordance with an example embodiment, there is provided an intelligent academic program guidance system for providing a user with an interactive engagement with respect to academic programs. The academic program guidance system includes a plurality of databases comprising an academic program database comprising program data related to a plurality of academic programs, and a user profile database comprising user data related to a plurality of users of the academic program guidance system; and a processor operable to: receive a user input in a natural language format to initiate the interactive engagement, the user input comprising one or more academic program inquiries; evaluate the user input to determine whether the user input is sufficient for determining an engagement intent of the user with the academic program guidance system; in response to determining the user input is sufficient to determine the engagement intent: translate the user input into one or more prompt inputs according to a set of academic engagement prompts, the set of academic engagement prompts providing a framework for correlating the user input against one or more databases of the plurality of databases; and generate a set of search queries based on the one or more prompt inputs for retrieving a set of response data from the one or more databases, the set of search queries comprises a user profile search query for retrieving a user profile for the user from the user profile database; and execute the set of search queries at the one or more databases to retrieve the set of response data to the user input, the set of response data comprising the program data identified from the one or more databases based at least on the user profile; and otherwise, generate one or more information requests for obtaining additional information for clarifying the engagement intent of the user with the academic program guidance system; and generate a program guidance output in reply to the user input based on the set of response data, the program guidance output being in the natural language format and addressing the one or more academic program inquiries.

In some embodiments, the processor is further operable to: determine that the user input lacks sufficient information for generating the engagement intent of the user with the academic program; and generate the one or more information requests for clarifying the engagement intent of the user based on one or more of the user input and the user profile of the user.

In some embodiments, the engagement intent comprises one or more of an initial inquiry intent for the user exploring different academic program options, and an advanced inquiry intent for the user knowledgeable about academic program options.

In some embodiments, the processor is further operable to: generate the set of search queries based on the one or more prompt inputs and the engagement intent of the user.

In some embodiments, the processor is further operable to: assess the user input to identify the one or more databases from which data is required for generating the program guidance output; and generate the one or more prompt inputs from the user input by referencing a context of the user input and the user profile, and the plurality of databases of the academic program guidance system.

In some embodiments, the processor is further operable to: determine, from the user input, that the user is not associated with the user profile stored in the user profile database; and generate the user profile for the user based at least on the user input.

In some embodiments, the processor is further operable to: request one or more user data requests for obtaining additional information on the user for generating the user profile.

In some embodiments, the processor is further operable to generate the program guidance output by applying one or more natural language generation techniques to the set of response data.

In accordance with an embodiment, there is provided a method of operating an intelligent academic program guidance system for providing a user with an interactive engagement with respect to academic programs. The method involves: receiving a user input in a natural language format to initiate the interactive engagement, the user input comprising one or more academic program inquiries; evaluating the user input to determine whether the user input is sufficient for determining an engagement intent of the user with the academic program guidance system; in response to determining the user input is sufficient to determine the engagement intent: translating the user input into one or more prompt inputs according to a set of academic engagement prompts, the set of academic engagement prompts providing a framework for correlating the user input against one or more databases of a plurality of databases of the academic program guidance system, the plurality of databases comprising an academic program database comprising program data related to a plurality of academic programs, and a user profile database comprising user data related to a plurality of users of the academic program guidance system; and generating a set of search queries based on the one or more prompt inputs for retrieving a set of response data from the one or more databases, the set of search queries comprises a user profile search query for retrieving a user profile for the user from the user profile database; and executing the set of search queries at the one or more databases to retrieve the set of response data to the user input, the set of response data comprising the program data identified from the one or more databases based at least on the user profile; and otherwise, generating one or more information requests for obtaining additional information for clarifying the engagement intent of the user with the academic program guidance system; and generating a program guidance output in reply to the user input based on the set of response data, the program guidance output being in the natural language format and addressing the one or more academic program inquiries.

In some embodiments, the method further involves determining that the user input lacks sufficient information for generating the engagement intent of the user with the academic program; and generating the one or more information requests for clarifying the engagement intent of the user based on one or more of the user input and the user profile of the user.

In some embodiments, the engagement intent comprises one or more of an initial inquiry intent for the user exploring different academic program options, and an advanced inquiry intent for the user knowledgeable about academic program options.

In some embodiments, the method further involves generating the set of search queries based on the one or more prompt inputs and the engagement intent of the user.

In some embodiments, the method further involves: assessing the user input to identify the one or more databases from which data is required for generating the program guidance output; and generating the one or more prompt inputs from the user input by referencing a context of the user input and the user profile, and the plurality of databases of the academic program guidance system.

In some embodiments, the method further involves: determining, from the user input, that the user is not associated with the user profile stored in the user profile database; and generating the user profile for the user based at least on the user input.

In some embodiments, the method further involves requesting one or more user data requests for obtaining additional information on the user for generating the user profile.

In some embodiments, the method further involves generating the program guidance output by applying one or more natural language generation techniques to the set of response data.

### BRIEF DESCRIPTION OF THE DRAWINGS

Several embodiments will be described in detail with reference to the drawings, in which:

FIG. 1 is a block diagram of an example intelligent academic program guidance system in communication with external components, in accordance with an example embodiment;

FIG. 2 is a flowchart of a method for providing a user with an interactive engagement with respect to academic programs in accordance with an example embodiment;

FIG. 3 is a block diagram showing components of an example intelligent academic program guidance system, in accordance with an example embodiment;

FIG. 4A shows a graphical user interface illustrating an example embodiment of an application of the intelligent academic program guidance system described herein;

FIG. 4B shows a graphical user interface illustrating an example embodiment of an application of the intelligent academic program guidance system described herein;

FIG. 5A shows a graphical user interface illustrating example embodiment of an application of the intelligent academic program guidance system described herein;

FIG. 5B shows a graphical user interface illustrating an example embodiment of an application of the intelligent academic program guidance system described herein; and

FIG. 6 shows a graphical user interface illustrating an example embodiment of an application of the intelligent academic program guidance system described herein.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to intelligent academic program guidance systems and associated methods of operating the systems.

The academic program into which an applicant enrolls and subsequently completes can have a short to medium-term impact on the applicant's happiness and well-being and can have a long-term impact on the employability and future success of the applicant. For many applicants, the process of identifying an academic program and an institution where they will complete the academic program can be stressful due, at least, to the volume of information available and/or lack of information available in some cases, and the large number of academic programs and institutions from which to select. Applicants will vary—some applicants may have preferences (e.g., location, types of programs, length of program) and may be aware of their strengths and weaknesses (e.g., stronger subjects), but some applicants may be unfamiliar with specific programs that would align with their preferences and be tailored to their strengths and weaknesses.

Even applicants who have familiarity with specific programs and institutions may be unfamiliar with admissions criteria or may underestimate or overestimate their chances of gaining admissions to an academic program of interest. It is also possible that admission criteria have changed recently—such instances may be more prevalent for international students as government regulations on foreign entry can change suddenly despite the institution's admission rules not having changed. Similarly, the soft factors related to admission may not be so clear from official resources. Obtaining this information for each program and institution can be tedious and impractical since the information is usually scattered across multiple webpages or resources. Additionally, some information may not be available publicly (e.g., different entrance requirements depending on the applicant's grading scheme).

In other cases, applicants may not have strong program preferences, as long as the academic program is one which is likely to lead to employment opportunities. Employment opportunities, however, can vary depending on academic institutions and academic programs, along with factors such as geographic location. Some academic institutions for example, may not be internationally renowned but may be located in areas with a high rate of employment. It can be difficult for applicants to identify academic programs that will lead to a high likelihood of employment when the applicant does not even know what programs to research.

Typically, to select an academic program, an applicant will rely on word-of-mouth advice from friends and family, and/or information available via online resources. This advice, however, is often unreliable, since information from friends and family is usually based on personal experience, hearsay or popularity of an academic program or institution, which can be outdated. Further, this process does not account for the applicant's personal preferences and situation. Oftentimes, when relying on word-of-mouth advice, applicants can be persuaded to enroll into certain academic programs due mostly to their associated popularity without considering whether they will enjoy the programs and whether the program will lead to post-graduation employment.

In some cases, the applicant may have the assistance of an academic advisor. While academic advisors can generally provide more informed advice when compared to friends and family, academic advisors' knowledge is often limited by their geographic location, academic programs in which they specialize, or past enrollment experience. In other words, they are likely to only be familiar with academic institutions located in a limited number of geographic locations and that have been attended by other students they have worked with. Further advisors may not be able to offer a comprehensive perspective specific to each applicant based on information beyond those experiences, such as the success of past applicants beyond the enrollment point.

In some cases, there may also be agreements between certain academic institutions and the school of the applicant, biasing the academic advisor's advice.

Applicants can also conduct independent research on the academic programs and the academic institutions. However, applicants typically limit the scope of their research to institutions and/or academic programs with which they have some familiarity. These academic institutions are typically those local to the applicant's geographical region, internationally known academic institutions, academic institutions that have been attended, or academic programs completed by those they know personally. Applicants may also refer to third-party lists identifying potential academic institutions, but these third-party lists are unlikely to be comprehensive or specific to that applicant's circumstances, are unlikely to account for the applicant's personal preferences, interests, skills and strengths, and may be biased (e.g., due to sponsorships, etc.) or contain inaccurate information.

Selecting an academic program that is not in accordance with the applicant's interests, preferences and employment goals can have potentially detrimental consequences since academic programs typically involve significant time and financial investments. These consequences can be magnified when the applicant has limited financial resources.

The systems and methods disclosed herein offer academic program guidance on academic programs to applicants based on a natural language user input. This guidance can offer valuable information to applicants and assist applicants in identifying academic programs that are likely to align with amongst other factors, their interests, preferences, skills and goals.

The academic program guidance systems disclosed herein can provide a graphical user interface through which it can receive a user input in a natural language format from a user and offer the user program guidance output(s) in a natural language format. The academic program guidance systems disclosed herein can interact with the user in a conversational manner, generating an output that can be easily understood by the user.

The systems and methods disclosed herein can operate as an intelligent interactive virtual agent that can converse with the user and can translate the user input expressed in natural language format into prompt inputs according to academic engagement prompts. The intelligent interactive virtual agent can converse with the user according to prompts that guide the intelligent interactive virtual agent's interaction with the user. The systems and methods can then correlate the user input against databases to be searched, and generate search queries based on the prompt inputs that can be used to search the databases. The disclosed embodiments can retrieve response data that includes program data that can identify academic programs that would be well-suited for the user, based on the user profile of the user.

The intelligent interactive virtual agent can accordingly provide customized guidance for each user and provide a personalized interaction each time a user interacts with the intelligent interactive virtual agent. When compared to traditional human advisors who may be working with multiple applicants at any one time and have limited time and mental resources to dedicate to each applicant, the intelligent interactive virtual agent can interact with each applicant individually without being time-constrained by other applicants' requests. The intelligent interactive virtual agent can search databases that store a large number of entries related to academic programs. When compared to human advisors who can struggle to distill an applicant's interests and intent into search parameters, the intelligent interactive virtual disclosed herein can more efficiently convert the applicant's request for information into search queries and retrieve information from databases.

The systems and methods disclosed herein can determine whether the user input is sufficient to determine an engagement intent of the user prior to translating the user input into input prompt(s) and request additional information, if necessary, so that the academic program guidance system can provide an output that is useful for the applicant and that is accordance with the intent of the user.

In some embodiments, the disclosed systems and methods can generate a user profile when a user input is not associated with a user profile, so that information about the user can be retrieved for future use.

The academic program guidance systems described herein can provide outputs that address each user's queries and that is unique to each user input. The academic program guidance systems described herein can determine and generate guidance outputs at runtime, when a user input is received, and can query databases at runtime according to the user input, that is, they do not require storing pre-determined correspondences between personas stored in database and program data, do not require maintaining personas and do not require associating each user to a pre-determined persona. The resulting output of the academic program guidance system is accordingly more customized to the user and the user's user input.

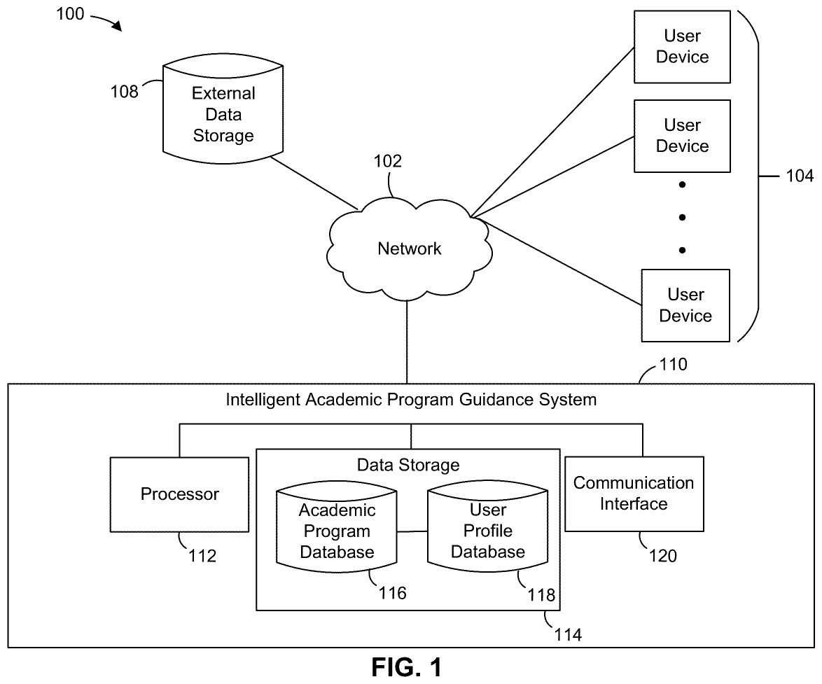

Reference is now made to FIG. 1, which shows a block diagram 100 of an example intelligent academic program guidance system 110 in communication with user devices 104 and an external data storage 108 via a network 102. For illustration purposes, multiple user devices 104 are illustrated in FIG. 1. It is understood that one or more user devices 104 can be used with the intelligent academic program guidance system 110 disclosed herein. The intelligent academic program guidance system 110 can communicate with the user device 104 and the external data storage 108 over a wide geographic area via the network 102. As described, the intelligent academic program guidance system 110 can operate as an intelligent interactive virtual agent and can be implemented as a network of intelligent interactive virtual agents.

The intelligent academic program guidance system 110 includes a processor 112, a data storage 114 and a communication interface 120. The intelligent academic program guidance system 110 can be implemented with more than one computer server distributed over a wide geographic area and connected via the network 102. The processor 112, the data storage 114 and the communication interface 120 may be combined into fewer components or may be separated into further components. The intelligent academic program guidance system 110 can include other components, in some embodiments.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the intelligent academic program guidance system 110. The processor 112 can include more than one processor and each processor can be configured to perform different dedicated tasks.

The communication interface 120 can include any interface that enables the intelligent academic program guidance system 110 to communicate with various devices and other systems. For example, the communication interface 120 can receive input data from a user device 104 or data from the external data storage 108 and process the data and/or receive input data from the user device 104 and store the data in the data storage 114 or the external data storage 108. The communication interface 120 may also include at least one of an Internet, Local Area Network (LAN), Ethernet, Firewire, modem or digital subscriber line connection. Various combinations of these elements may be incorporated within the communication interface 120.

The data storage 114 can include RAM, ROM, one or more hard drives, one or more flash drives or some other suitable data storage elements such as disk drives, etc. The data storage 114 includes an academic program database 116 and a user profile database 118. The data storage 114 may include one or more other databases. For example, the data storage 114 can include a database storing an operating system and can include a memory unit used to store computer programs. The programs include various user programs so that a user can interact with the intelligent academic program guidance system 110 including, but not limited to, viewing and manipulating data. The data storage 114 can additionally store academic engagement prompts, relations between databases and relations between academic engagement prompts and databases. In some embodiments, the data storage 114 stores information about previous applicants, including association with academic programs (and academic institutions) to which they have applied, application outcomes and employment outcomes upon completion of the academic program.

The academic program database 116 can store information related to, for academic institutions, academic programs and employment types. The information may also be stored in the external data storage 108 as a backup storage solution, or some portions of the information may be stored remotely in the external data storage 108 and accessed by the intelligent academic program guidance system 110 as needed. The academic program database 116 can be subdivided into two or more databases. For example, the different types of information can be stored in a plurality of databases and/or each data source can be associated with one or more databases.

Information related to institutions that may be stored in the academic program database 116 may include, but is not limited to, an academic level or type (e.g., university, college, high school, public or private, etc.), a geographical location, notable features or offerings, key statistical data (e.g., average cost of living, average tuition, average length of program, application fee, top disciplines, etc.), whether the country where the academic institution requires visas, and available academic programs. Information related to academic programs that may be stored in the data storage 114 may include, but not limited to, tuition fee, application fee, a program length, entry requirements (e.g., minimum grades, minimum grades assessed against country of education, English proficiency tests, standardized test results, level of education required) and key statistics, such as typical acceptance statistics. Information related to employment types that may be stored in the academic program database 116 may include, but not limited to, typical entry requirements (e.g., minimal education level or academic program, etc.), careers associated with the academic programs and average salary at graduation. The information stored in the academic program database 116 can originate from various data sources. At least a portion of the information stored in the academic program database 116 can be information retrieved from external data sources, including publicly available data sources and/or from academic institutions.

The user profile database 118 can store user profiles containing information related to users. Information related to a user that may be stored in the user profile database 118 may include, but is not limited to, general information about the user that may typically be stored in a user profile, including personal information (e.g., name, birthdate, contact information, etc.), a user profile identifier identifying the user, and a login identifier and password for accessing the intelligent academic program guidance system 110. The user of the intelligent academic program guidance system 110 may be an applicant. The information that can be stored in respect of the applicant can include, but is not limited to, nationality, education background, grades, study language proficiency and foreign study permit/visa availability. The user profile database 118 can store interactions between the user and the intelligent academic program guidance system 110, for example, conversations between the user and the intelligent academic program guidance system 110 or information extracted from interactions between the user and the intelligent academic program guidance system 110, for example, skills, interests and preferences of the user (e.g., location preferences, academic institution preferences, preferred fields of study, tuition budget, start date, salary preferences, employment types preferences).

In some embodiments, a user profile for a user can be generated via a questionnaire administered to the user. For example, the questionnaire can include questions relating to the user's education background, grades, nationality, skills, interests, preferences, etc.

The user device 104 can include any computing device that is capable of receiving an input from a user and communicating with the intelligent academic program guidance system 110 via the network 102. The user device 104 may communicate with the network 102 through a wired or wireless connection. In some embodiments, the connection request initiated from the user device 104 may be initiated from a web browser and directed at a browser-based communications application on the intelligent academic program guidance system 110.

The user device 104 can include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. The user device 104 can also include a communication interface that can receive input from various input devices, such as a mouse, a keyboard, a touch screen, a thumbwheel, a track-pad, a track-ball, voice recognition software and the like, depending on the requirements and implementation of the user device 104 and of the intelligent academic program guidance system 110. The communication component of the user device 104 can also include an interface that enables the user device 104 to communicate with the intelligent academic program guidance system 110.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the academic program advisory system 110, the user device 104 and the external data storage 108.

The external data storage 108 can store data similar to that of the academic program database 114 and the user profile database 116. For example, the external data storage 108 can store information related to, but not limited to, the users of the intelligent academic program guidance system 110, academic institutions, academic programs and/or types of employments. The external data storage 108 can, for example, be a network attached storage (NAS) or a cloud storage. The data stored in the external data storage 108 can be retrieved by the intelligent academic program guidance system 110 via the network 102.

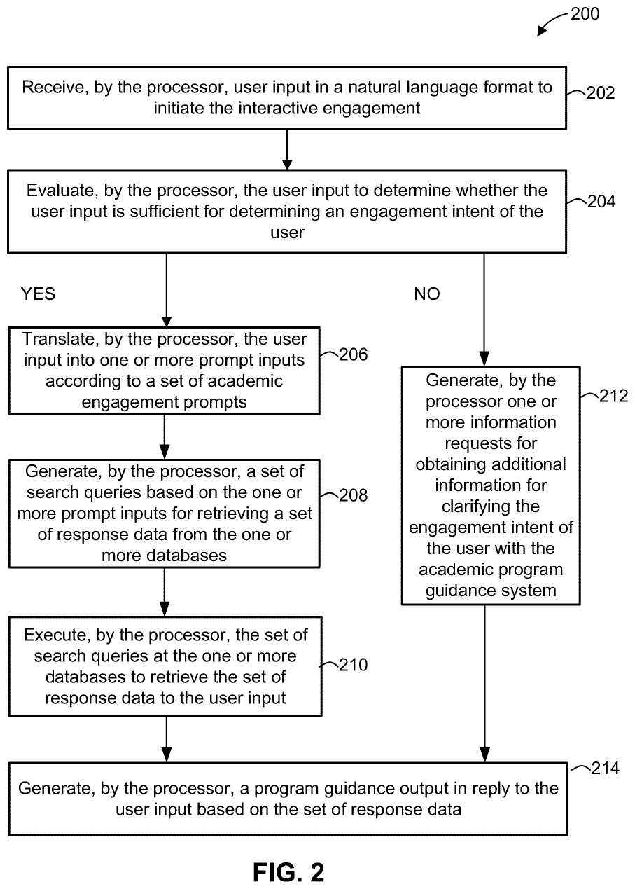

Reference is now made to FIG. 2, which shows a flowchart 200 of an example operation of the intelligent academic program guidance system 110 to provide a user with an interactive engagement with respect to academic programs.

At 202, the processor 112 receives a user input in a natural language format to initiate the interactive engagement. The user input can include one or more academic program inquiries. For example, the user input can include a request for information about academic programs or academic institutions offering the academic programs or a request for recommended academic programs/academic institutions offering the academic programs. As other examples, the user input can include requests for information about application fees, the status of an application, application cycles, eligibility criteria, changing academic programs, grading schemes and grade conversion and any other request for information or question related to academic programs, academic institutions and applications.

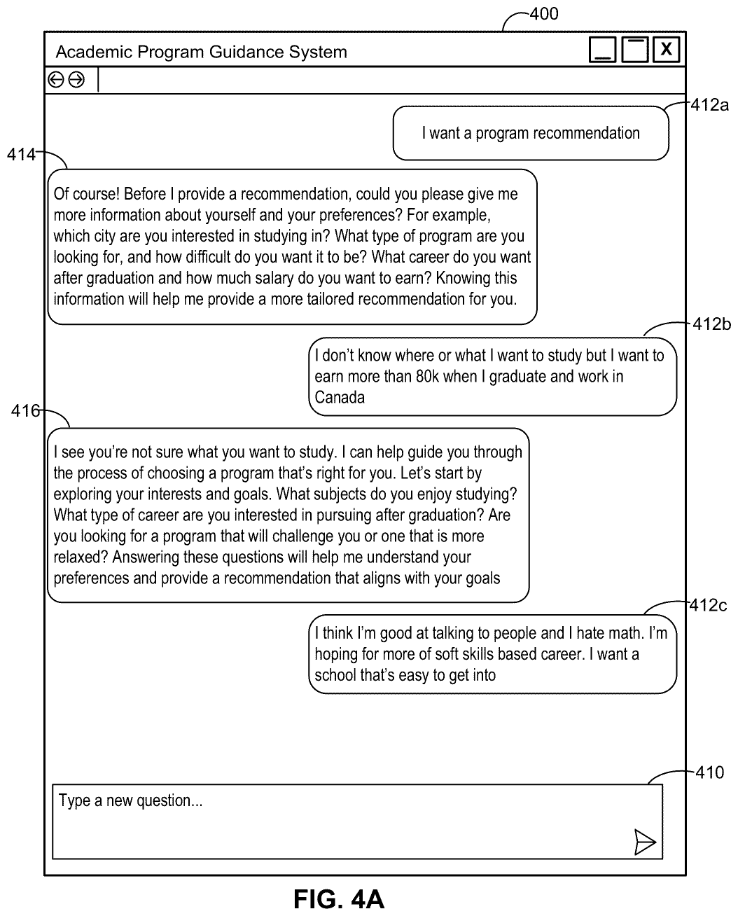

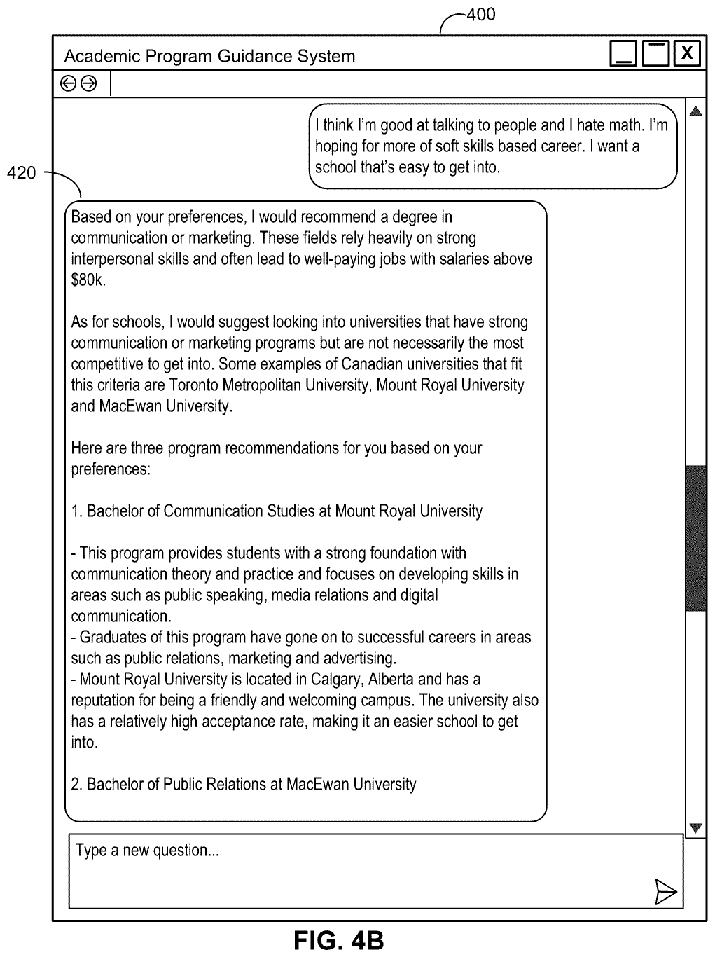

Briefly, FIGS. 4A-4B show an example user interface 400 illustrating an application of the intelligent academic program guidance system 110. As shown, the user can provide the user input by typing text into the box 410. For example, as shown by messages 412a, 412b, the user can request a program recommendation.

At 204, the processor 112 evaluates the user input to determine whether the user input is sufficient to determine an engagement intent of the user with the academic program guidance system 110. For example, the processor 112 can determine whether, based on the user input, the academic program guidance system 110, can understand the intent of the user such that a guidance output could be generated or whether the user input is too vague, unspecific, or lacks sufficient information for the academic program guidance system 110 to determine an intent of the user in order to generate a guidance output.

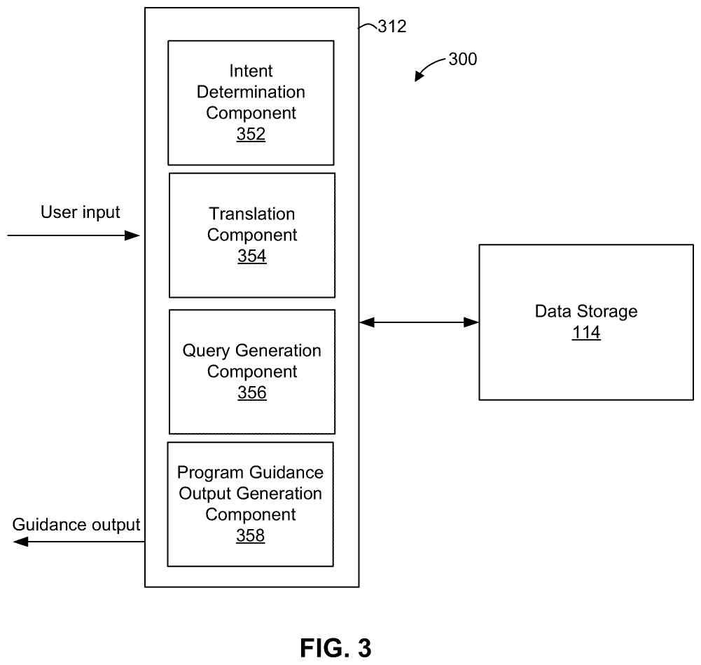

Referring briefly to FIG. 3, which shows a block diagram 300 of example components implemented by an example processor 312 of the academic program guidance system 110, in communication with the data storage 114. The processor 312 can implement an intent determination component 352, a translation component 354, a query generation component 356 and a program guidance output generation component 358.

The intent determination component 352 can parse the user input to determine an engagement intent of the user input. For example, the intent determination component 352 can use soft-computing techniques including one or more intention models to evaluate the user input to determine the engagement intent.

The engagement intent can include an initial inquiry intent for the user exploring different academic program options and/or an advanced inquiry intent for the user knowledgeable about academic program options.

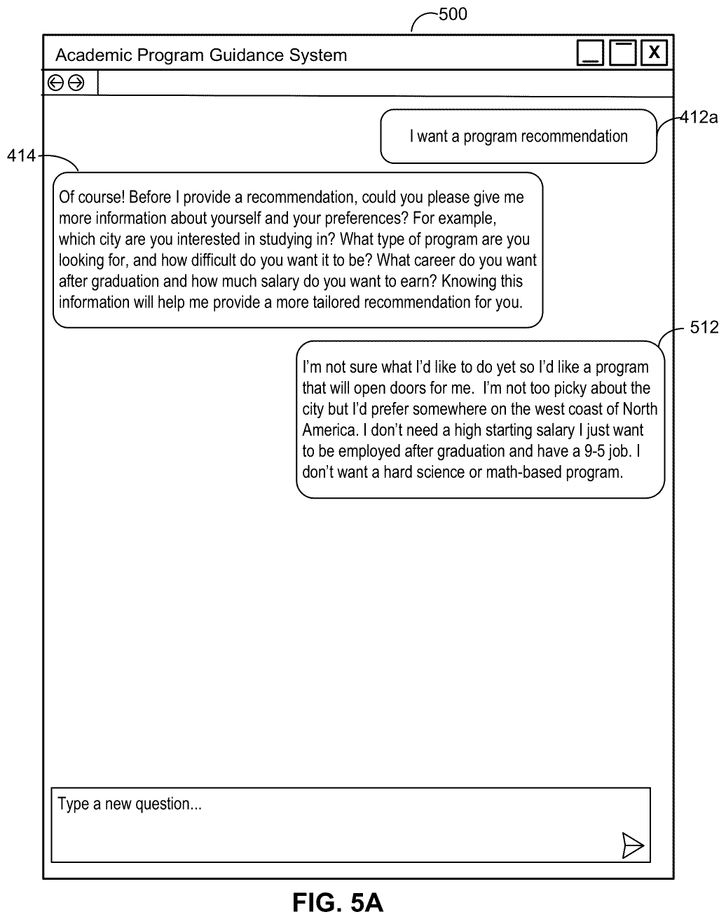

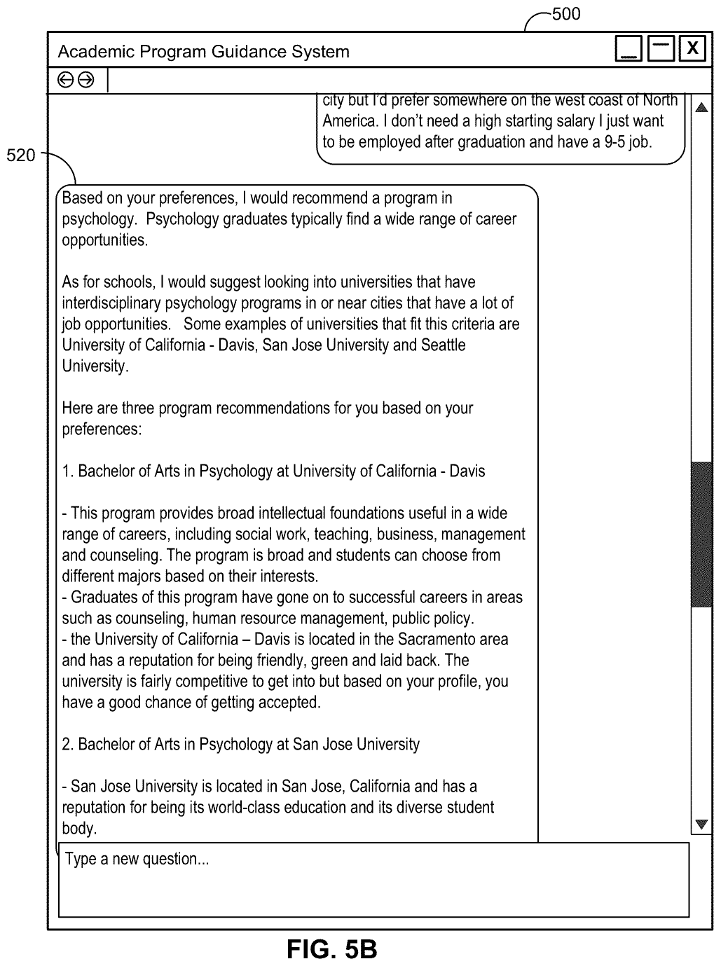

For example, as shown in the example user interface 500 of FIG. 5A, the user input 512 can indicate that the user has some knowledge of their interests, preferences and of academic programs but is still exploring or unsure about the specific program they may want to pursue. The engagement intent associated with this user input 512 can accordingly include an initial inquiry intent.

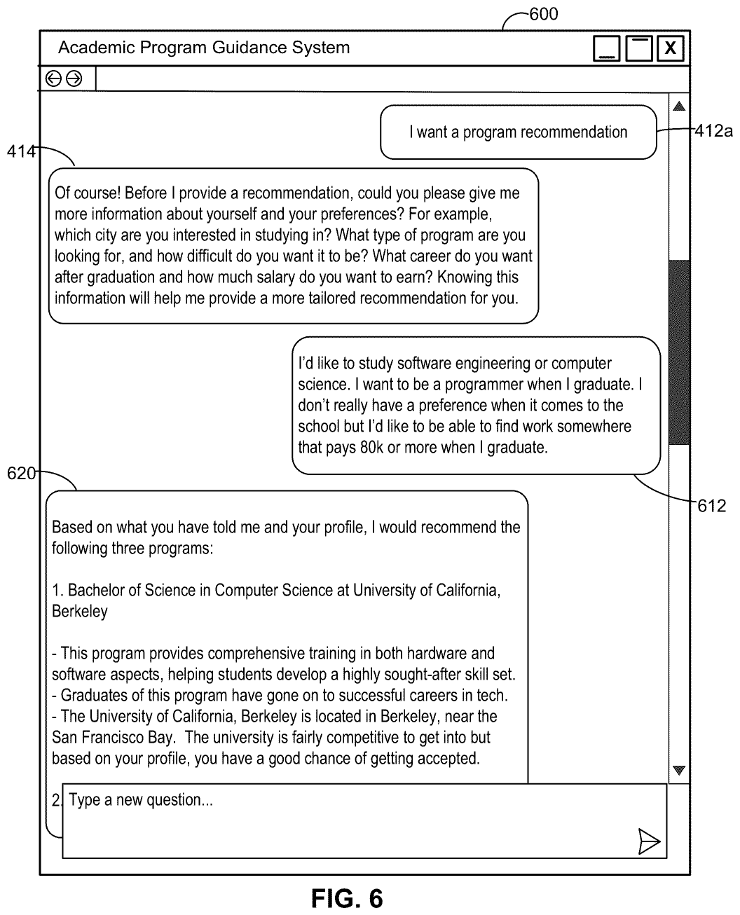

As another example, as shown in the example user interface 600 of FIG. 6, the user input 612 can indicate that the user is knowledgeable about academic programs, for example, the user knows the type of academic program the user may be interested in. The engagement intent associated with the user input 612 can accordingly include an advanced inquiry intent.

As explained, in some embodiments, the engagement intent can include an initial inquiry intent and an advanced inquiry intent. For example, during an interaction between the user and the academic program guidance system 110, the user input can include two or more messages, wherein the first is associated with an initial inquiry intent and the second is associated with an advanced inquiry intent.

When the intelligent academic program guidance system 110 determines that the user input received at 202 is sufficient to determine the engagement intent, the method 200 proceeds to 206. Otherwise, the method 200 proceeds to 212.

At 206, the processor 112 translates the user input received at 202 into one or more prompt inputs according to a set of academic engagement prompts. The set of academic engagement prompts can provide a framework for correlating the user input against one or more databases, for example one or more databases in the data storage 114 and can help guide the intelligent academic program guidance system 110 to understand the user input of the user. For example, the academic engagement prompts can be used to express a user input in terms that can be understood by the processor 112 and that can enable the processor 112 to search the databases of the academic program guidance system 110. The academic engagement prompts can be predefined and stored in the datastore 114.

Returning to FIG. 3, the translation component 354 can translate the user input into one or more prompt inputs. For example, the translation component 354 can parse the user input to understand the user's query. The prompt inputs can correspond to the academic program guidance system's 110 understanding of the user's query as expressed through the user input and can enable the intelligent academic program guidance system 110 to provide personalized guidance for the user.

For example, based on the user input “Can you show me programs in the United Kingdom that fit me?”, the translation component 354 can translate the user input into the prompt inputs “programs in the United Kingdom” that “fit the user's profile”. The prompt inputs can be structured according to the academic engagement prompts. The prompt inputs “programs in the United Kingdom” and “that fit the user's profile” can be associated with searchable properties of the information stored in the data storage 114 that can be searched by the intelligent academic program guidance system 110.

As another example, returning to FIG. 5A, the user input comprised in message 512 “I'm not sure what I'd like to do yet so I'd like a program that will open doors for me. I'm not too picky about the city but I'd prefer somewhere on the west coast of North America. I don't need a high starting salary I just want to be employed after graduation and have a 9-5 job. I don't want a hard science or math-based program.” can be translated into the prompt inputs “programs on the west coast of North America”, “that is not science-based”, “that is not math-based” and “that has high post-graduation employment rates”.

In some embodiments, the processor 112 assesses the user input to identify the database(s) from which data is required for generating the program guidance output and generates the prompt input(s) from the user input by referencing a context of the user input and the user profile, and the databases of the intelligent academic program guidance system 110. For example, as described previously, the processor 112 can retrieve previous conversations associated with the user and/or previous messages within the current conversation to generate the prompt input(s). The prompt inputs can enable the intelligent academic program guidance system 110 to provide customized guidance for the user since each conversation with the user can be unique.

Since the prompt inputs can be translated according to a set of academic engagement prompts that are correlated with the databases that the academic program guidance system 110 can search, multiple natural language user inputs can be associated with similar prompt inputs.

For example, the user inputs comprised in the messages “I want to study in the United Kingdom” and “Show me programs in the United Kingdom” can both be associated with the prompt input “programs in the United Kingdom”. Depending on the information stored in the databases, the set of academic engagement prompts and the input prompts can vary. In some embodiments, the prompt input can be personalized to the user, for example, based on the data specific to the user stored in the databases.

In some embodiments, the translation component 354 can include one or more models that can take as input the user input and convert the user input into prompt inputs. In some embodiments, one or more additional prompt inputs can be generated based on the prompt inputs generated by the translation component 354. For example, the academic program guidance system 110 can determine that one or more additional prompt inputs are complementary with the prompt inputs generated.

Returning to FIG. 2, at 208, the processor 112 generates a set of search queries based on the one or more prompt inputs for retrieving a set of response data from the one or more databases. The search queries can be database queries. As explained the search queries are generated dynamically, based on the one or more prompt inputs determined at 206, that is, associations between search queries and prompt inputs are not pre-stored. The dynamic generation of search queries can allow the processor 112 to generate search queries that account for changes in the one or more databases of the data storage 114 and that account for the engagement intent of the user. The search queries can include search queries associated with the one or more prompt inputs and additional search queries based on the search queries associated with the one or more inputs. Referring back to FIG. 3, the search query generation component 356 can generate the set of search queries. The search queries can be expressed in the form of a computer language that allows the processor 312 to make queries in the data storage 114. For example, the search queries can be in the form of a Structured Query Language (SQL) query, vector index k-cluster functions, etc. The computer language of the search query can vary, depending on the database searched and/or the source of the data and can be selected according to the type of information searched in the databases.

Since information stored in the data storage 114 can originate from various sources, different search queries can be generated according to the different data structures of the different sources.

The set of search queries can include a user profile search query that can retrieve a user profile for the user from the user profile database 118. As explained, the program guidance output generated by the academic program guidance system 110 can be specific to the user. By retrieving the user profile for the user, the academic program guidance system 110 can search for academic program data that is tailored to the user's interests, skills, personal characteristics, preferences, etc. For example, if the user profile includes preferences relating to tuition budget, the academic program guidance system 110 can search for programs that are within the user's budget.

In some embodiments, the academic program guidance system 110 can query the user profile associated with the user and extract factors that may be relevant for searching the databases. For example, the academic program guidance system 110 can determine that certain preferences of the user (e.g., tuition budget, preferred field of study, etc.) may be relevant to the search.

As explained, in some embodiments, the user profile can store information about interactions between the user and the academic program guidance system 110, for example, previous conversations. In such embodiments, by retrieving the user profile for the user, the academic program guidance system 110 can obtain information about previous user inputs.

For example, the current user input can indicate that the user is interested in a program with a high acceptance rate and in a geographic location that has access to a large employment market. Based on a previous interaction between the user and the academic program guidance system 110, it may be determined that the user has additionally expressed interest in social sciences program and would prefer a smaller academic institution. By retrieving the user profile for the user, the academic program guidance system 110 can obtain additional information about the user that may not be included in the user input.

In some embodiments, the set of search queries is generated based on the engagement intent of the user in addition to the prompt input(s). For example, the set of search queries can vary depending on whether the engagement intent is an initial inquiry intent or an advanced inquiry intent.

In some embodiments, the processor 112 can determine that a user is not associated with a user profile stored in the user profile database 118. For example, the user may be a user who is interacting with the academic program guidance system 110 for the first time. When the processor 112 determines that the user is not associated with a user profile stored in the user profile database 118, the processor 112 can generate a user profile for the user based at least on the user input received at 202. The processor 112 can then store the generated user profile in the user profile database 118 for future use.

In some embodiments, when the processor 112 determines that the user is not associated with a user profile stored in the user profile database 118, the processor 118 requests one or more user data requests for obtaining additional information on the user to generate the user profile. For example, the processor 112 can request additional information about the user from the user, via the graphical user interface 400. The additional information can include any information typically associated with a user profile, for example, academic information about the user (e.g., grades, education background), personal information about the user, demographic information about the user and interests, skills and preferences of the user. In some embodiments, the user data requests can be in the form of a questionnaire. For example, the academic program guidance system 110 can provide questions to the user and generate the user profile based on the answers to the questions. In some embodiments, the processor 112 can generate the user profile by extracting information about the user when the user is interacting with the academic program guidance system 110.

In some embodiments, the processor 112 can obtain additional information on the user from an external system. For example, in some cases, the processor 112 may obtain information about the user's grades from a system associated with the user's previous or current academic institution and/or from another interactive virtual agent which has previously obtained information about the user's grades.

At 210, the processor 112 executes the set of search queries at the one or more databases, for example, the databases stored in the data storage 114 and/or the external data storage 108 to retrieve the set of response data to the user input. The set of response data can include the program data identified from the one or more databases based at least on the user profile. For example, the processor 112 can retrieve academic programs and information related to the academic programs that match the academic program inquiries comprised in the user input and the user profile.

Returning to FIG. 3, as shown, the processor 312 can communicate with the data storage 114 to search the databases. For example, the processor 312 can search an academic program database and apply one or more filters according to the information included in the user's profile.

As explained, a user's user profile can indicate that the user has a maximum tuition budget. The academic program guidance system 110 can accordingly search for programs that fit within the user's tuition budget. The academic program guidance system 110 can apply other preferences to identify academic programs that are consistent with the user's preferences.

In some embodiments, executing the search queries involves searching a database containing information about previous applicants (e.g., applicant profiles) and identifying applicant profiles that are similar to the user profile, extracting applicant profiles that are associated with the most positive employment outcomes and extracting information from the extracted applicant profiles.

In some embodiments, executing the search queries involves parsing the data storage 114 and filtering the information contained in the data storage 114 based on the search queries. For example, the information contained in the data storage 114 can be structured in a table format and executing the search queries can involve identifies entries in the table that satisfy the search queries. For example, the table entries satisfying the search queries can correspond to table entries that satisfy preferences of the user as determined by the user profile of the user and/or the user input.

As explained, when the intelligent academic program guidance system 110 determines that the user input received at 202 is not sufficient to determine the engagement intent, the method 200 proceeds to 212.

At 212, the processor 112 generates one or more information requests for obtaining additional information for clarifying the engagement intent of the user with the intelligent academic program guidance system 110.

In some embodiments, the one or more information requests for clarifying the engagement intent of the user are based on the user input and/or the user profile.

For example, based on the user input the processor 112 can identify information that can clarify the engagement intent of the user and generate one or more information requests that are likely to prompt the user to provide the information clarifying the engagement intent of the user. Referring back to FIG. 4A, the user input 412a can indicate that the user would like a program recommendation. The processor 112 can determine that to clarify the engagement intent of the user, information about the user and the user's preferences, for example, location preferences, program preferences, salary preferences, should be provided. Accordingly, the processor 112 can generate information request in message 414. As another example, based on the user profile, the intelligent academic program guidance system 110 can determine that certain preferences of the user are already known and accordingly may not generate information request(s) that relate to known preferences of the user. As another example, the intelligent academic program guidance system 110 can generate information request(s) according to known academic strengths of the user, based on the user profile.

In some embodiments, the intelligent academic program guidance system 110 can generate the information requests according to guidance prompts that provide guidelines for the intelligent academic program guidance system 110. For example, the intelligent academic program guidance system 110 can be configured to avoid generating certain types of information requests that may not be relevant to generating an academic program guidance output or to provide answers to user inputs that are not relevant to generating an academic program guidance output. As another example, the intelligent academic program guidance system 110 can be configured to favor information requests that include questions to the user that are relevant to generating an academic program guidance output.

Alternatively, or in addition thereto, based on the information in the user profile, the processor 112 can identify information that could clarify the engagement of the user. For example, based on the user's grades, the processor 112 can infer that the user is likely to want recommendations for academic programs that are less competitive and the processor 112 can generate one or more information requests that can confirm the processor's 112 inference.

In some embodiments, at least some of the one or more information requests can be pre-determined and may not be based on the user input or the user profile. For example, it may be determined that some standardized information requests typically allow the academic program guidance system 110 to obtain information that clarifies the engagement intent of the user.

The processor 112 can maintain a knowledge of information types that can clarify the engagement intent of the user and generate the one or more information requests based on the information which has not been provided via the user input.

The processor 112 can generate one or more of the one or more information requests in response to a user input providing additional information. For example, the processor 112 can generate an information request for obtaining additional information, receive a user input that includes additional information, evaluate the user input and determine that the user input that includes the additional information is still insufficient to determine an engagement intent of the user. In this example, the processor 112 can generate one or more additional information requests for clarifying the engagement of the intent. In some embodiments, the processor 112 can generate information requests until an engagement intent of the user can be determined.

Referring briefly again to FIG. 4A, message 416 can be generated to obtain additional information from the user. As shown in FIG. 4A, message 416 can include one or more questions to guide the user to provide information that can allow the processor to determine an engagement intent of the user with the intelligent academic program guidance system 110. A user input providing additional information, as exemplified by message 412c can then be received.

At 214, the processor 112 generates a program output in reply to the user input in a natural language format.

Referring briefly to FIG. 3, the guidance output generation component 358 of the can receive the response data and generate an output based on the response data. The program output can be based on the set of response data and address the one or more academic program inquiries. In some embodiments, the program guidance output is generated by applying one or more natural language generation techniques to the set of response data. For example, the response data retrieved may be in table format, or in computer language format and accordingly, natural language generation techniques can be applied to the response data so that the program guidance output generated and provided to the user can be readable and understood by the user.

The program output can include one or more recommended academic programs and one or more institutions offering the academic programs.

For example, as shown in FIG. 4B, 5B and 6 the program guidance output is provided via messages 420, 520, 620 which include a list of recommendation academic programs and institutions and an explanation of the recommendation.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

We claim:

1. An intelligent academic program guidance system for providing a user with an interactive engagement with respect to academic programs, the academic program guidance system comprising:
a plurality of databases comprising an academic program database comprising program data related to a plurality of academic programs, and a user profile database comprising user data related to a plurality of users of the academic program guidance system; and
a processor operable to:
receive a user input in a natural language format to initiate the interactive engagement, the user input comprising one or more academic program inquiries;
evaluate the user input to determine whether the user input is sufficient for determining an engagement intent of the user with the academic program guidance system;
in response to determining the user input is sufficient to determine the engagement intent:
translate the user input into one or more prompt inputs according to a set of academic engagement prompts, the set of academic engagement prompts providing a framework for correlating the user input against one or more databases of the plurality of databases; and
generate a set of search queries based on the one or more prompt inputs for retrieving a set of response data from the one or more databases, the set of search queries comprises a user profile search query for retrieving a user profile for the user from the user profile database; and
execute the set of search queries at the one or more databases to retrieve the set of response data to the user input, the set of response data comprising the program data identified from the one or more databases based at least on the user profile; and
otherwise, generate one or more information requests for obtaining additional information for clarifying the engagement intent of the user with the academic program guidance system; and
generate a program guidance output in reply to the user input based on the set of response data, the program guidance output being in the natural language format and addressing the one or more academic program inquiries.
The academic program guidance system of claim 1, wherein the processor is further operable to:
determine that the user input lacks sufficient information for generating the engagement intent of the user with the academic program; and
generate the one or more information requests for clarifying the engagement intent of the user based on one or more of the user input and the user profile of the user.

2. The academic program guidance system of claim 1, wherein the engagement intent comprises one or more of an initial inquiry intent for the user exploring different academic program options, and an advanced inquiry intent for the user knowledgeable about academic program options.

3. The academic program guidance system of claim 1, wherein the processor is further operable to:
generate the set of search queries based on the one or more prompt inputs and the engagement intent of the user.

4. The academic program guidance system of claim 1, wherein the processor is further operable to:
assess the user input to identify the one or more databases from which data is required for generating the program guidance output; and
generate the one or more prompt inputs from the user input by referencing a context of the user input and the user profile, and the plurality of databases of the academic program guidance system.

5. The academic program guidance system of claim 1, wherein the processor is further operable to:
determine, from the user input, that the user is not associated with the user profile stored in the user profile database; and
generate the user profile for the user based at least on the user input.
The academic program guidance system of claim 6, wherein the processor is further operable to:
request one or more user data requests for obtaining additional information on the user for generating the user profile.

6. The academic program guidance system of claim 1, wherein the processor is further operable to:
generate the program guidance output by applying one or more natural language generation techniques to the set of response data.

7. A method of operating an intelligent academic program guidance system for providing a user with an interactive engagement with respect to academic programs, the method comprising:
receiving a user input in a natural language format to initiate the interactive engagement, the user input comprising one or more academic program inquiries;
evaluating the user input to determine whether the user input is sufficient for determining an engagement intent of the user with the academic program guidance system;
in response to determining the user input is sufficient to determine the engagement intent:
translating the user input into one or more prompt inputs according to a set of academic engagement prompts, the set of academic engagement prompts providing a framework for correlating the user input against one or more databases of a plurality of databases of the academic program guidance system, the plurality of databases comprising an academic program database comprising program data related to a plurality of academic programs, and a user profile database comprising user data related to a plurality of users of the academic program guidance system; and
generating a set of search queries based on the one or more prompt inputs for retrieving a set of response data from the one or more databases, the set of search queries comprises a user profile search query for retrieving a user profile for the user from the user profile database; and
executing the set of search queries at the one or more databases to retrieve the set of response data to the user input, the set of response data comprising the program data identified from the one or more databases based at least on the user profile; and
otherwise, generating one or more information requests for obtaining additional information for clarifying the engagement intent of the user with the academic program guidance system; and
generating a program guidance output in reply to the user input based on the set of response data, the program guidance output being in the natural language format and addressing the one or more academic program inquiries.
The method of claim 9, further comprising:
determining that the user input lacks sufficient information for generating the engagement intent of the user with the academic program; and
generating the one or more information requests for clarifying the engagement intent of the user based on one or more of the user input and the user profile of the user.

8. The method of claim 9, wherein the engagement intent comprises one or more of an initial inquiry intent for the user exploring different academic program options, and an advanced inquiry intent for the user knowledgeable about academic program options.

9. The method of claim 9, further comprising:
generating the set of search queries based on the one or more prompt inputs and the engagement intent of the user.

10. The method of claim 9, further comprising:
assessing the user input to identify the one or more databases from which data is required for generating the program guidance output; and
generating the one or more prompt inputs from the user input by referencing a context of the user input and the user profile, and the plurality of databases of the academic program guidance system.

11. The method of claim 9, further comprising:
determining, from the user input, that the user is not associated with the user profile stored in the user profile database; and
generating the user profile for the user based at least on the user input.
The method of claim 14, further comprising:
requesting one or more user data requests for obtaining additional information on the user for generating the user profile.

12. The method of claim 9, further comprising:
generating the program guidance output by applying one or more natural language generation techniques to the set of response data.
